(19) United States
(12) Patent Application Publication
(10) Pub. No.: US 2008/0193139 A1
(43) Pub. Date: Aug. 14, 2008

(54) Two-Way Communication in an Autonomous in Vivo Device

(76) Inventor: Ido Bettesh, Haifa (IL)

Correspondence Address: Pearl Cohen Zedek Latzer, LLP, 1500 Broadway, 12th Floor, New York, NY, 10036, US

(21) Appl. No.: 11/791,978

(22) PCT Filed: Dec. 1, 2005
(86) PCT No.: PCT/IL2005/001289

§ 371 Date: Nov. 15, 2007

Related U.S. Application Data
(60) Provisional application No. 60/631,858, filed on Dec. 1, 2004.

(51) Int. Cl. H04B 10/00

(52) U.S. Cl. 398/128

(57) ABSTRACT

An autonomous in-vivo sensing device that includes a transceiver that may for example transmit wireless signals to for example an external receiver, and receive wireless signals from for example an external transmitter. In some embodiments the wireless signals received by such device may include control or command signals that may activate, de-activate or alter an operational state of one or more components of the device.

### FIELD OF THE INVENTION

The present invention relates to two-way communication by an in-vivo sensing device, and more particularly, to the transmission and receipt of wireless signals by an in-vivo sensing device.

### BACKGROUND OF THE INVENTION

Autonomous in-vivo sensing devices are known. Certain autonomous in-vivo sensing devices include functions that may be activated or deactivated in response to various signals or stimuli such as for example the passage of time, a change in environmental conditions such as change of scenery, or other factors.

### SUMMARY OF THE INVENTION

According to an embodiment of the invention a device, system and method are provided for an autonomous in-vivo sensing device that includes an in-vivo transceiver to both transmit wireless signals to, for example, an external receiver, and to receive wireless signals from, for example, an external transmitter. In some embodiments, the transceiver may be a half duplex transceiver that may alternate between transmission and reception. In other embodiments of the present invention, the transceiver may transmit at a higher rate than it may receive. In yet other embodiments of the present invention, reception may be by wide bandwidth communication, e.g. spread spectrum communication. Typically, the wireless signals transmitted by the in-vivo transceiver may be or may include sensed data such as, for example, image data that may be collected by the in-vivo sensing device. According to embodiments of the present invention, the wireless signals received by the transceiver may be command signals to alter one or more operation state of the in-vivo device.

### BRIEF DESCRIPTION OF THE DRAWINGS

The subject matter regarded as the invention is particularly pointed out and distinctly claimed in the detailed description in the specification. The invention, however, may best be understood by reference to the following detailed description when read with the accompanied drawings in which:

FIG. 1 depicts an in-vivo sensing device and an associated system in accordance with an embodiment of the present invention;

FIG. 2A shows an on/off keying (OK) that may be used as a transmission signal to an in-vivo device according to an embodiment of the present invention;

FIG. 2B shows the frequency characteristic of an on-off keying (OOK) signal that may be used as a transmission signal to an in-vivo device according to an embodiment of the present invention;

FIG. 3A shows an on/off keying modulation combined with a variable frequency signal that may be used as a transmission signal to an in-vivo device according to another embodiment of the present invention;

FIG. 3B shows the frequency characteristic of an on/off keying modulation combined with variable frequency signal that may be used as a transmission signal to an in-vivo device according to another embodiment of the present invention;

FIG. 4A shows a constant envelope modulated carrier signal that may be used as a transmission signal to an in-vivo device according to another embodiment of the present invention;

FIG. 4B shows an on/off keying modulation combined with a frequency sweep signal that may be used as a transmission signal to an in-vivo device according to another embodiment of the present invention

FIG. 5 shows schematically a portion of a transmitter for transmitting a constant envelope signal with a wide frequency bandwidth according to an embodiment of the present invention;

FIG. 6 shows schematically a block diagram of the circuitry for the receiver part of a transceiver according to an embodiment of the present invention;

FIG. 7 shows one or more symbols composed of a sequence of narrow OOK pulses according to an embodiment of the present invention;

FIG. 8 shows a block diagram of a transmitter for transmitting OOK pulses according to an embodiment of the present invention;

FIG. 9 shows a block diagram of the circuitry for reception of OOK pulses according to an embodiment of the present invention;

FIG. 10 shows a diagram with circuitry for a demodulator receiver according to embodiments of the present invention;

FIG. 11 shows a modified FSK scheme spectrum according to an embodiment of the present invention;

FIG. 12 shows a hard limiter FSK receiver according to an embodiment of the present invention;

FIG. 13 shows a portion of a transmitter for transmitting an FSK modulated signal according to an embodiment of the present invention; and

FIG. 14 shows a flow chart of a method in accordance with an embodiment of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

It is noted that some embodiments of the present invention may be directed to an autonomous, typically swallowable in-vivo device. Other embodiments need not be swallowable. Devices or systems according to embodiments of the present invention may be similar to embodiments described in International Application WO 01/65995 and/or in U.S. Pat. No. 5,604,531, each of which are assigned to the common assignee of the present invention and each of which are hereby fully incorporated by reference. Furthermore, a receiving and/or display system suitable for use with embodiments of the present invention may also be similar to embodiments described in WO 01/65995 and/or in U.S. Pat. No. 5,604,531. Devices and systems as described herein may have other configurations and other sets of components. For example, devices and systems described herein maybe used for controlled drug delivery, for example, to a target location, as may be described by in PCT publication WO 00/22975, published on Apr. 27, 2000 and which is assigned to the common assignee and which is hereby fully incorporated by reference. Alternate embodiments of a device, system and method according to various embodiments of the invention may be used with other devices, non-imaging and/or non-in-vivo devices.

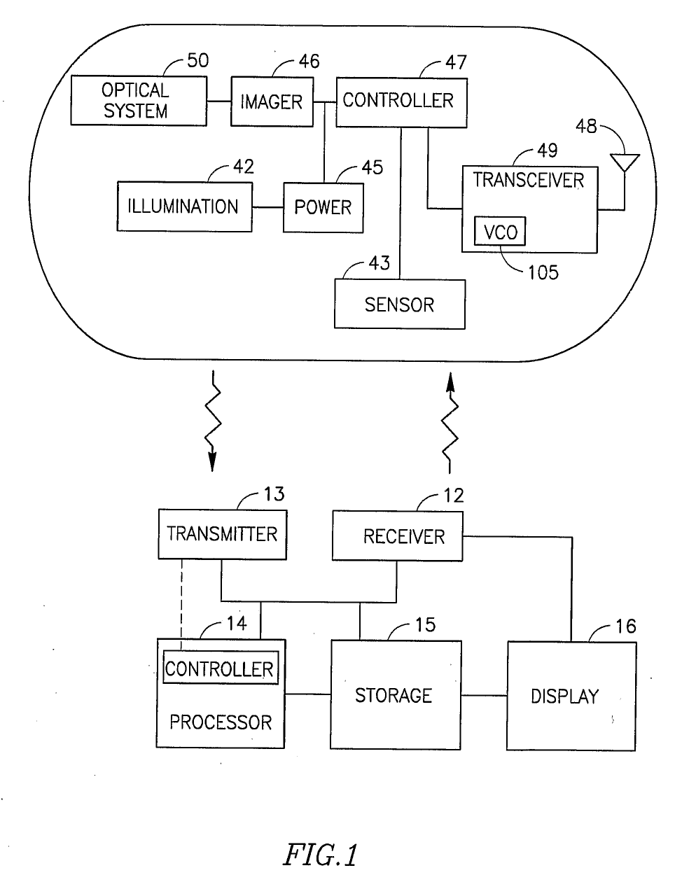

Reference is made to FIG. 1, which shows a schematic diagram of an embodiment of an in-vivo sensing device and an external receiver and transmitter system in accordance with an embodiment of the invention. In one embodiment, the system may include a device 40 having an imager 46, an optical system 50, a sensor 43, an illumination source 42, a power source 45 such as for example one or more batteries and a controller 47. Controller 47 may be implemented as a processor, FPGA (Field Programmable Field Array) or by a similar implementation. Other components or sensors may also be included. Controller 47 may, for example, be capable of processing signals that are received by device 40 into for example command or control signals that may control, activate, deactivate or otherwise alter an operative state of components that may be included in device 40. Device 40 may include a transceiver 49 that may be capable of receiving wireless signals and transmitting wireless signals. Transceiver 49 may also have other functions. In some embodiments, transceiver 49 and controller 47 may be or may be included in a single integrated circuit or other device. Device 40 may include antenna 48 that may be operably attached to transceiver 49. In some embodiments, antenna 48 may be used for, or in the performance of, both the receipt and transmission of wireless signals by transceiver 49. In other embodiments there may be more than one antenna such as for example a receiver antenna and/or a transmitter antenna.

Device 40 typically may be or may include an autonomous swallowable capsule, but may have other shapes, and need not be swallowable or autonomous. For example, device 40 may be a capsule or other unit where all the components are substantially contained within a container, housing or shell, and where device 40 may not require a wired or cabled connection to, for example, receive power or transmit information. In one embodiment, device 40 may collect sensed data from the GI tract while it passes through the GI lumen. Other lumens may be imaged.

External to device 40 may be a receiver 12, transmitter 13, a controller 17, a storage unit 15 and a display unit 16. Receiver 12, which may be a receiver/recorder, and transmitter 13 (typically including or associated with an antenna or antenna array) may be housed or included in the same housing or unit, or may be housed in one or more separate units. For example, transmitter 13 and receiver 12 may be housed in a portable unit that may be carried or worn by a patient and/or may be integrated into a transceiver.

Receiver 12 may be connected to and/or in electrical communication with a processor 14 which may process, for example, data signals such as, for example, sensed data signals that are received from device 40 and/or control data received from device 40. In some embodiments, processor 14 may be operably connected to the display 16 and/or a storage system 15 that may display and/or store the image or other sensed data collected and transmitted by device 40. Processor 14 may analyze data received by receiver 12 and may be in communication with storage system 15, transferring image data (which may be stored and transferred as for example frame data) or other data to and from storage system 15. Processor 14 may also provide the analyzed data to display 16 where a user may view the images. Display 16 may present or display the data such as, for example, image frame data or video data of, for example, the gastro-intestinal (GI) tract or other body lumen. In one embodiment, processor 14 may be configured for real time processing and/or for post processing to be performed. Other monitoring and receiving systems may be used.

In some embodiments, transmitter 13 and controller 17 may be housed in a receiver that may, for example, be worn by a patient in which device 40 is placed. In some embodiments, transmitter 13 and controller 17 may be housed elsewhere and may be housed separately. For example, controller 17 may be operably connected to receiver 12 such that an external operator who may for example view sensed data on display 16 may activate transmitter 13 to deliver a wireless signal to transceiver 49.

Transmitter 13 may typically be connected to and/or in electrical communication with a processor 14. Processor 14 may function, at least partially as a controller and/or include, for example, a controller 17 to process, for example, control commands/instructions to device 40 via transmitter 13. In other embodiments of the present invention, signals other than control commands/instructions may be processed by processor 14 with, for example, controller 17 and transmitted via transmitter 13. In yet other embodiments, controller 17 and processor 14 may be separate units that may be in electrical communication with each other. In some embodiments of the present invention, control commands/instructions generated, for example, by controller 17 may be based on data received by receiver 12 and processed by processor 14. In some other embodiments of the invention, controller 17 may generate commands and/or instructions, based on signals representing measurements received at receiver 12. In other embodiments, control commands/instructions generated, by controller 17 may be based on, user input data, for example, a patient or external operator may for example, initiate the transmission of a wireless signal and/or command from, for example, transmitter 13 to transceiver 49. In yet other embodiments, control commands/instructions may be based on both user input data and data receiver and/or processed by processor 14.

In some embodiments, transceiver 49 may be a half duplex transceiver where the transceiver 49 alternates from transmitting to receiving, e.g. via time division multiple access (TDMA). Typically, the transmission rate to the external receiver 12 may be significantly higher than the transmission rate from external transmitter 13 to the transceiver 49. For example, device 40 may transmit, e.g. image frame data at a first rate to external receiver 12 at a rate of 1-10 Mbits/s, e.g. 2.7 Nvbits/s, while transmitter 13 may transmit control commands/instructions to the transceiver 49 that may be at rate of 10-30 Kbits/sec.

In operation, in some embodiments, device 40 may be placed, inserted or ingested into a body lumen such as for example the GI tract or other body lumen. In some embodiments, imager 46 may capture images of portions of the body lumen and such images or image data may be transmitted by transceiver 49 to for example receiver 12, where an external operator may view or some other function may analyze the transmitted data. At one or more times, such as for example in response to a reading, analysis or image that may be transmitted by device 40, an external operator may use an input device, e.g. keyboard, dial etc. or some other automated or manual function or process to send a command to controller 17 to transmit a wireless signal such as for example a control signal from transmitter 13 to transceiver 49. In response to such wireless signals, transceiver 49 and/or controller 47 may issue a command, control or other signal to for example sensor 43, imager 46 or to some other component of device 40. In some embodiments a signal to a particular component of device 40 may be issued by way of or through controller 47. In response to such signal, a component or sensor such as for example sensor 43 or imager 46 may be activated, de-activated or may otherwise alter its state of operation. Other actions, functions or processes of device 40 such as for example activation time, light intensity, release of an encapsulated liquid or powder, change in buoyancy, frame capture rate, image resolution, tissue sample collection, transmission power or other auxiliary functions may be activated, deactivated or otherwise altered in response to a signal received by transceiver 49.

In another embodiment of the invention, controller 17 may analyze parameters of the signal received at receiver 12. Such parameters may be, for example, received power, signal quality, frequency offset, modulation index or any other characteristic parameter of the signal. Based on the analysis controller 17 may transmit commands and/or instructions from transmitter 13 to transceiver 49. These commands and/or instructions may be used by controller 47 to improve characteristics of the signal transmitted from transceiver 49 to receiver 12. Improving signal characteristics may include for example, ensuring that signal power is sufficient to guarantee good signal quality at receiver 12, correct modulation index, correct carrier frequency and the like. The commands and/or instructions issued by processor 14 with using, for example, controller 17, may be generated both automatically and manually.

Power source 45 may include one or more batteries. For example, power source 45 may include silver oxide batteries, lithium batteries, other suitable electrochemical cells having a high energy density, or the like. Other power sources may be used. For example, instead of internal power source 45 or in addition to it, an external power source may be used to transmit power to device 40.

In some embodiments, sensor 43 may be or include, for example, pH, temperature, pressure or other physiological parameter sensors.

Size and power constraints of typical autonomous in-vivo devices may, for example, restrict the circuitry size and/or reception capability of an in-vivo receiver. According to some embodiments of the present invention, spread spectrum communication may be implemented for high power transmission of, for example, a constant envelope signal to an in-vivo device.

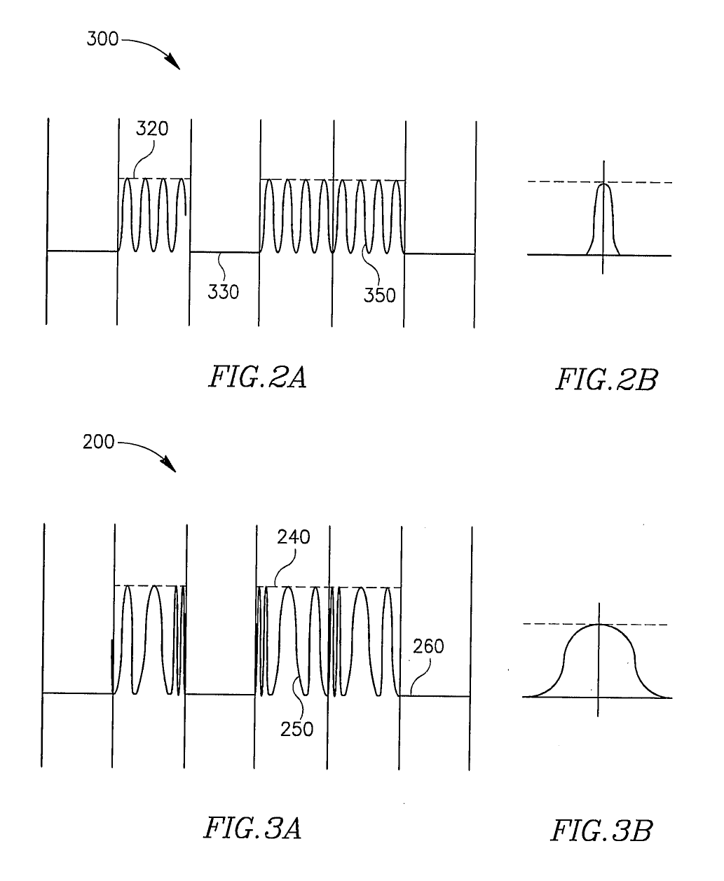

Reference is now made to FIG. 2A showing a constant envelope signal that may be used as a transmission signal to an in-vivo device according to an embodiment of the present invention. In some embodiments of the present invention, a simple amplitude modulated signal may be used during transmission to device 40 to minimize the circuitry required for reception and/or deciphering of the signal transmitted. The simplest form of an amplitude modulated signal may be for example, an on/off keying (OOK) modulation signal 300, with constant frequency carrier signal 350 that may typically be used in short range devices (SRD). Some of the advantages of using an OOK modulation may be that for example, no A/D or digital signal processing (DSP) may be required, OOK modulation may be less sensitive to phase noise and frequency error, and the constant envelope signal serves to transmit power efficiently.

Typically, each symbol in the OK may assume one of the two values: a logical ‘mark’, (e.g. ‘1’) or a logical ‘space’, (e.g., ‘0’). Other encodings and meanings may be used. For mark 320, the transmitter 13 may transmit a carrier signal 350 with a constant frequency, Fc, during the entire mark symbol. For space 330, the transmitter may not transmit anything. The transceiver 49 may measure during each symbol the received energy and decide if a mark 320 or space 330 may have been transmitted. A schematic diagram of the OOK modulation signal in the frequency domain, according to one embodiment, is shown in FIG. 2B. The transmission power of the mark or symbol may be determined in the frequency domain, for example, by the integral of the spectral density (SD) gain over the bandwidth of the carrier signal 350 using known methods. For an OOK modulation the typically narrow bandwidth of, for example, signal 300 may limit the total transmission power.

Typically for in-vivo devices, reception may be hampered, for example, due to attenuation known to occur through the body tissues, so that higher transmission power may be needed. However, regulations, e.g. Federal Communication Control (FCC) or other regulatory standards may limit the spectral density gain to, for example, 50.5 dBuV/m for FCC (or lower for similar regulations in other countries) so that the transmission power, for example, a transmission power of approximately −12 dBm that may be required, which may be difficult to achieve.

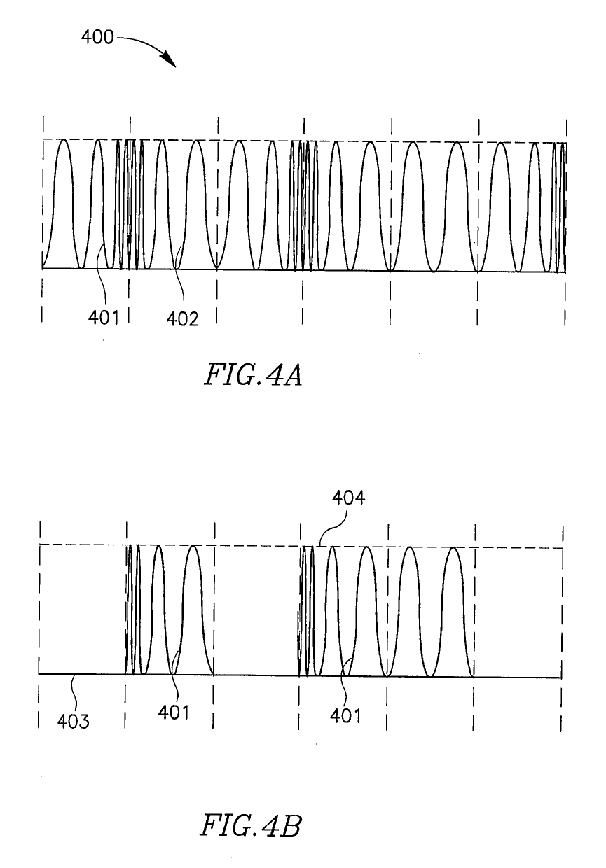

Reference is now made to FIG. 3A showing schematically an OOK combined With variable frequency signal that may be implemented for transmission of command signals to an in-vivo transceiver 49 according to some embodiments of the present invention. In one embodiment of the present invention, for a symbol such as mark 240, the transmitter 13 may transmit a variable frequency signal, for example, a chirp signal, with higher mark symbol amplitude as compared to mark symbol amplitude 320 and for a symbol such as space 260 the transmitter may not transmit anything. For example, using the modulation described by FIG. 2A may produce a maximal power of −23 [dBm] while the modulation in FIG. 3A which may reach −9 [dBm] under the same regulatory limits. The higher mark symbol amplitude may, for example, compensate for attenuation that may occur through the body tissue. The variable frequency carrier signal may, for example, serve to diffuse the spectral density over a larger range of frequencies. This combination of increasing the amplitude of the mark or symbol amplitude while transmitting at a variable and/or wideband frequency may, for example, enable command signals to be successfully received by an in-vivo device without overstepping the upper boundary of FCC, or other regulations for communication signals. Transmitted carrier frequency 250 may be a variable frequency carrier that may range, for example, between 3-10 MHz. Other suitable ranges may be used. The corresponding frequency domain of this signal is shown schematically in FIG. 3B. Introducing a variable or wide band carrier frequency 250 may serve to increase the total transmission power while maintaining a specified (or required, e.g., by regulation standards) spectral density power, e.g. such as the spectral density power shown in FIG. 2B. The extra power may be obtained, for example, by increasing the bandwidth of the carrier signal in the frequency domain. Therefore, in some embodiments of the present invention, it may be possible to increase the total transmission power to a desired level as long as the bandwidth may be increased in the same proportion. Typically, the transmitted signal may have low requirements on frequency stability and phase noise, since such a receiver may consider only the amplitude and may disregard the frequency component of the carrier signal. For such a receiver, the use of a single frequency or varying frequencies may have the same effect as long as the total power may be the same. An additional advantage to such an embodiment may be that a narrow (band pass filter) BPF typically requiring substantial circuitry, may not be required. As such, according to embodiments of the present invention, commands/instructions signals received with wide input bandwidth may be deciphered, for example, as may be described herein. In other embodiments of the present invention, it may be possible to use continuous phase frequency shift keying (CPFSK) with for example 2 or more bits/symbol in order to reach a flat spectrum and/or to increase the bit rate. In other embodiments, the bit rate may be increased by for example, increasing the symbol rate. Other suitable signals may be used to transmit command signals using spread spectrum communication.

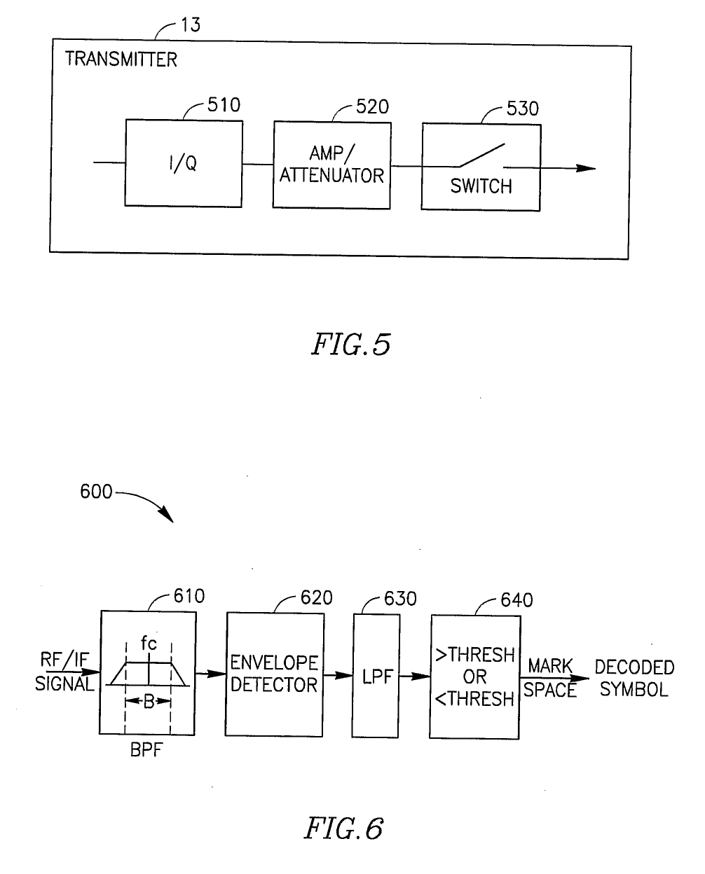

Reference is now made to FIG. 5 schematically showing a portion of a transmitter 13 for transmitting an OOK signal having a wide frequency bandwidth and/or spread spectrum according to an embodiment of the present invention. In one embodiment of the present invention, a component such as for example, an I/Q modulator 510 may be used to create a wide bandwidth and/or spread spectrum carrier signal. The signal may be amplified by amplifier 520 to a desired gain. Amplifying the signal to the desired gain may facilitate reception of the signal in-vivo despite attenuation. A switch 530 may be used to create a mark space modulated signal. Other methods and/or components such as, for example, a scrambler, may be used to generate a signal having a spread spectrum.

Reference is now made to FIGS. 4A and 4B, which schematically show a modulated carrier frequency 400 and constant envelope signal that may be used as a transmission signal to an in-vivo device according to an embodiment of the present invention.

According to some embodiments of the invention, a transmitter such as transmitter 13 may transmit a variable frequency signal, which may be, for example, a chirp signal as depicted in FIG. 4A. Generating a variable frequency having a chirp pattern may be referred to as frequency sweep. The frequency of the chirp signal or other signal may vary symmetrically around a carrier frequency (Fc), e.g., 13.56 MHz ±150 kHz. In addition, the chirp signal may increase in frequency, (e.g., up-chirp) 401 or decrease in frequency (e.g., down-chirp), 402 each representing a logical statement at the transceiver 49 as depicted in FIG. 4B. For example, FIG. 4B depicts the up-chirp 403, which may represent a logical ‘0’ or space and the down-chirp 404, which may represent a logical ‘1’ or ‘mark’ at, for example, transceiver 49. Other encodings and meanings may be used. Using the chirp signal or another variable frequency carrier signal may, for example, serve to diffuse the spectral density over a large range of frequencies. In addition, the data signal may be a constant envelope signal, which may be generated easily. In some embodiments of the invention, the speed of the frequency sweep may be changed over certain bands. For example, slowing down the frequency sweep in the down-chirp signal near Fc, may result in transmitting more power in this band.

It may be noted that the modulation structure using a chirp signal may be similar to Manchester coding as known in the art. Therefore, the modulation structure may be invariant to frequency shifts, which may improve the performance of the communication. Other variable frequency methods may be used.

Reference is made to FIG. 6 showing schematically a block diagram of the circuitry for the receiver 600 of the transceiver 49 in, for example, an in-vivo device 40 according to an embodiment of the present invention. According to one embodiment of the present invention, the receiver 600 may be a typical fixed gain non-coherent OOK receiver that may typically be used, for example, in short range devices (SRD(s)) to receive commands/instructions in the form of a constant symbol envelope signal. In other embodiments, other suitable receivers or components in the receiver 600 circuitry may be used and/or other suitable signals besides OOK modulated signals may be received. Typically, in an OOK receiver circuitry 600, a band pass filter (BPF) 610 may be implemented to limit the noise (and/or select the expected carrier frequency (Fc) of the signal) and an envelope detector (620) may be implemented for detecting marks 320 and spaces 330 of the received signal. In some embodiments of the present invention, the BPF may be naturally provided by antenna 48. Antenna 48 may be an inductor in parallel to some capacitance that may function as a BPF. According to one embodiment, the center carrier frequency (Fc) may be adjusted by controlling the capacity parallel to the antenna. In other embodiments, a BPF other than the antenna may be included. Typical envelope detectors may include suitable log amplifiers and/or suitable diode and RC circuits. One or more low-pass filters (LPF) 630 may be introduced for smoothing effect, and thresholding 640 may be implemented for deciding if the symbol is mark (above threshold) or space (below threshold). The LPF may be, for example, a typical integrate and dump unit for eliminating the noise from the envelope. Other suitable methods of smoothing may be implemented. In other embodiments, receiver 600 may be a logarithmic amplifier receiver, demodulator receiver, IF receiver, or other suitable receiver.

In some embodiments of the present invention, the signal rate transmitted to the transceiver 49 may be in the order of approximately 10-30 Kbits/s and thus may typically require a BPF of the same order as the receiver. However, due to, for example, constraints in space, power, etc., that may exist in an autonomous, typically self contained in-vivo device it may not be possible to implement a narrow BPF. A much wider BPF, for example, a 3-10 MHz filter, that may be implemented may not be suitable for narrow band signal since it may receive along with the transmitted signal a lot of noise and interferences. In some embodiments of the present invention described herein, a transmission signal and transmitter may be provided that may be suitable for transmitting a low data rate, e.g. 10-30 Kbits/s of data, over a wide bandwidth, e.g. spread spectrum to an in-vivo device 40. However other ranges of BPFs may be used and in other embodiments of the present invention, narrow BPF may be incorporated in the transceiver 49.

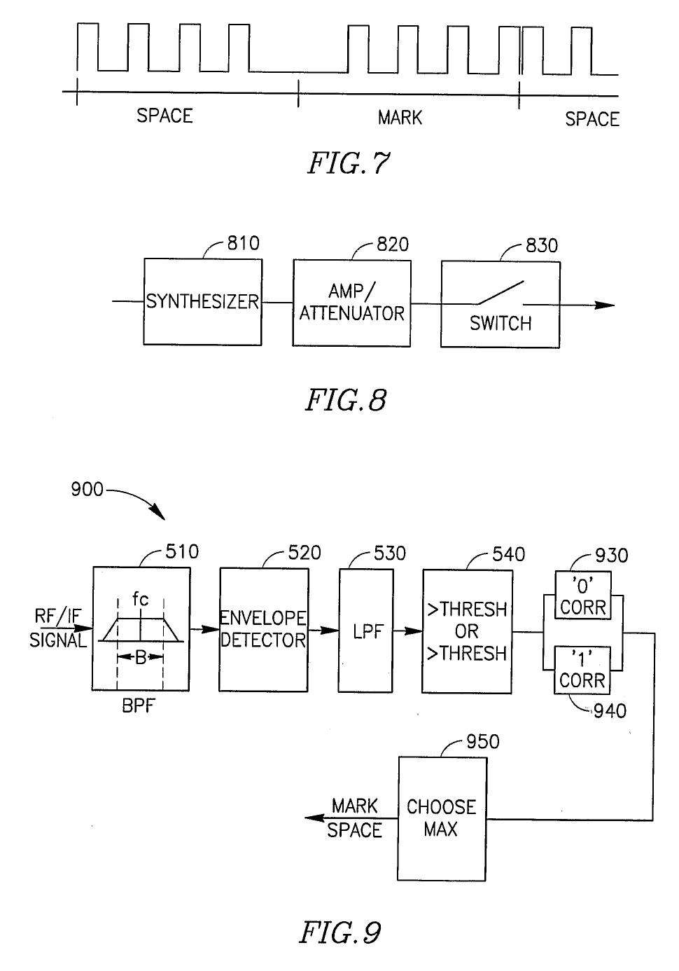

In an alternate embodiment of the present invention, each symbol may be composed of a Barker or PN sequence of narrow OOK chips or pulses. Other sequences may be used such as for example the sequence shown in FIG. 7 where a mark may be represented by, for example a ‘0101’ sequence of pulses while a space may be represented by a ‘1010’ sequence of pulses. Other suitable sequences may be used to distinguish between marks and spaces. The width of the pulses in the time domain may be inversely proportional to the width of the bandwidth in the frequency domain. For spread spectrum communication, the wide bandwidth may be obtained by implementing a series of narrow pulses in the time domain. For example, 10 MHz bandwidth may require pulses of 100 ns each. Thus, for example, for a 20 Kbit/s data rate there may be 500 OOK pulses in each symbol. Multiple pulses may facilitate better correlation to determine more accurately the beginning and end of a symbol. One or more symbols composed of a sequence of narrow OOK signals are shown in FIG. 7.

Reference is now made to FIG. 8 showing a block diagram of a transmitter for transmitting OOK pulses according to an embodiment of the present invention. According to one embodiment of the present invention, a synthesizer (810) may be implemented to generate a constant carrier frequency. In block 820 the carrier frequency may be, for example, adjusted, e.g. amplified and/or attenuated to the desired amplitude level. In block 830 the pulses may be generated using an on/off switch. In other embodiments of the present invention, other suitable components may be used and other suitable methods of generating pulses may be implemented.

Reference is now made to FIG. 9 showing a block diagram of the circuitry that may be required for reception of OOK pulses according to an embodiment of the present invention. Such circuitry may be implemented, for example, in transceiver 49. According to one embodiment of the present invention, the receiver may be a typical On/Off Keying (OOK) receiver with additional circuitry to identify if a symbol is ‘mark’ or ‘space’. Typically an OOK receiver 900 may be similar to the receiver shown in FIG. 6 and described herein with a digital add-on. In one embodiment of the present invention, the digital add-on may include a ‘0’ correlation block 930 and ‘1’ correlation block 940. The ‘0’ correlation block 930 and ‘1’ correlation block 940 may be used to identify the pulses and correlate the sequence of pulses and/or chips. In block 950 the symbol may be determined as either a mark symbol or a space symbol. Other suitable methods implementing spread spectrum communication may be used.

In alternate embodiments of the present invention, the receiver part of transceiver 49 may be a demodulator receiver. In one embodiment of the present invention, a voltage controlled oscillator 105 (VCO) of the transmitter part of transceiver 49 may be used as a demodulator during reception. Under this embodiment, the transmitter's VCO may be activated in (constant wave) CW mode without modulation. Since the same antenna may be used for both transmission and receiving. The VCO 105 may, for example, serve as a front-end receiver for the received signal. The received signal frequency may be required to be outside the PLL bandwidth (<101 kHz) to avoid attenuation by the synthesizer loop. However, the receiver signal frequency may need to be maintained close to the synthesizer frequency so that the VCO 105 amplification capabilities may be implemented. As such, the VCO 105 may, for example, be used to amplify the received signal. In addition the non-linearity inherent to the VCO 105 may serve a mixer between the CW and the receiver signal.

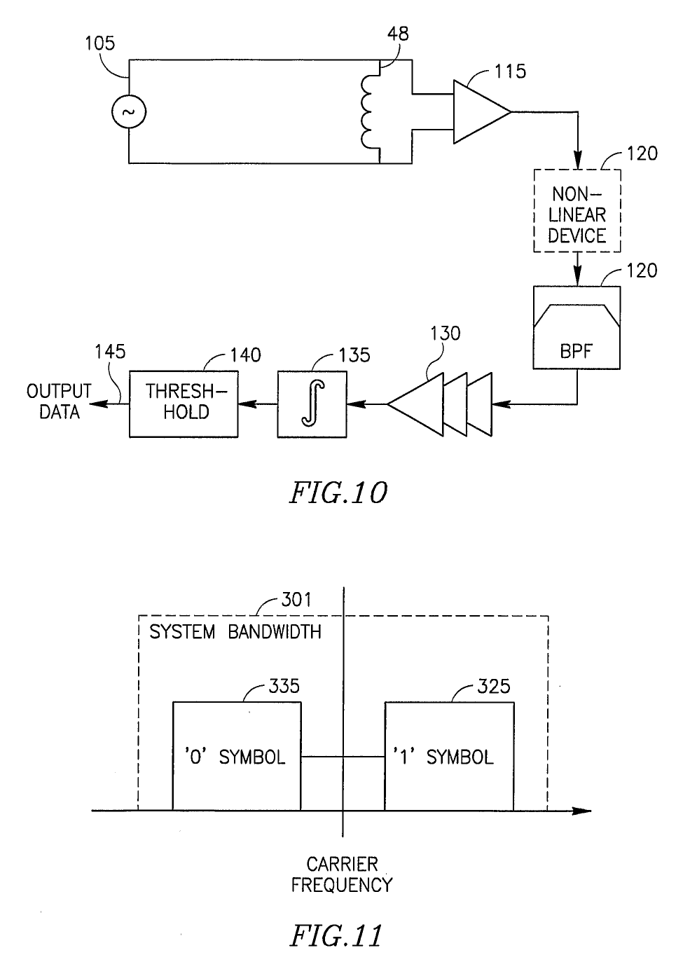

Reference is now made to FIG. 10 showing the circuitry that may be implemented in a demodulator receiver according to an embodiment of the present invention. Such a demodulator receiver may be included in, for example, transceiver 49. In addition to VCO 105 and antenna 48, the circuitry may include, for example, a low noise amplifier 115, a non-linear device 120, a band pass filter 125 (BPF), a logarithmic amplifier 130, an integrator 135 and a threshold check method and/or system 140 resulting in output data 145. In some embodiments of the present invention, non-linear device 120 may be required if, for example, non-linearity of the VCO 105 may not be high enough. Non-linear device 120, which may be, for example, a RC and diode circuit, may be used for demodulation. In other embodiments the non-linearity of VCO 105 may be high enough and VCO 105 may serve as a mixer where the low frequency product may be taken from a varactor bridge of VCO 105 (the varactor bridge may receive the output of the loop filter). In that case the non-linear device in FIG. 10 may be redundant. The demodulated signal may be filtered using a BPF 125 and may go through a logarithmic amplifier 130 as may be described herein. Alternatively, the BPF 125 may be replaced by a LPF, for example, when there may be no DC component in the output of non-linear device 120. In another embodiment, logarithmic amplifier 130 may be replaced by a simple RC and diode or hard limiter detector, for example, when the signal to noise ratio (SNR) may be high enough. Advantages of the demodulator receiver may be that very few additional blocks may be required to provide reception capability to a transmitting in-vivo device. Another advantage may be that there may be no need for high gain amplifiers and that the logarithmic amplifier may operate in the IF frequency. Other components and methods for providing a demodulating amplifier may be implemented.

Reference is now made to FIG. 11 describing a modified FSK modulation scheme in the frequency domain according to another embodiment of the present invention. For transmission of ‘1’ symbol 325 a wideband signal located in frequencies above the carrier frequency may be transmitted. Similarly, for transmission of ‘0’ symbol 335 a wideband signal located in frequencies below the carrier frequency may be transmitted. In some embodiments of the present invention, the ‘0’ and ‘1’ symbol may be confined to the system bandwidth 301. In other embodiments of the present invention, the wideband signal for ‘0’ and ‘1’ may be switched, other ranges of frequencies may be used for transmission of ‘0’ and ‘1’, or other suitable methods using FSK modulation may be used.

The wideband signal may be created using several techniques. According to one embodiment of the present invention, a chirp signal may be used. The chirp signal may be defined, for example, as a constant envelope signal with a linear sweep of frequencies. The range of frequency sweep may be, for example, chosen according to the bandwidth of the system 301. The frequency sweep range may change, for example, according to the symbol transmitted. The demodulator may have to decide whether the frequency transmitted may be either above or below the carrier frequency or other specified frequency. The FSK receiver may be a FSK receiver that may be used for both regular and modified FSK modulation schemes. Other suitable FSK receivers may be used.

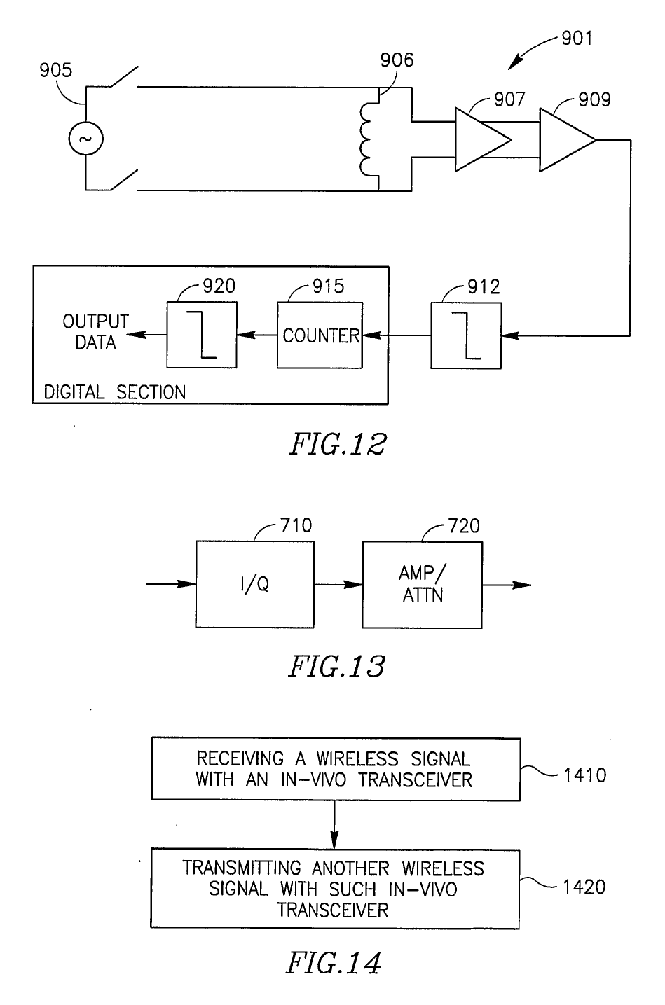

Reference is now made to FIG. 12 showing a hard limiter receiver structure according to an embodiment of the present invention. Such a receiver may be included in, for example, transceiver 49. The receiver may be based on a standard synthesizer circuit where a coil of a VCO 905 may serve as an antenna 906 while VCO 905 itself may be disconnected. A receiver 901 may count the zero crossings of the received signal during each symbol (335, 325). The number of zero crossings may be compared with a threshold to reach a binary decision. The gain required may be minimal, for example, a gain which may allow a hard limiter 912 to operate. An advantage of this embodiment may be that a counter 915 may be implemented using the synthesizer dividers which may already exist. It may be possible to simplify the scheme even further by dividing the output of the hard limiter 912 by a constant before counting the results. This may decrease the dynamic range of the counter 915. Another possibility may be to use existing units of the synthesizer even more. Assume that for ‘1’ symbol 325 we transmit a frequency which may be above the carrier frequency and for ‘0’ symbol 335 we transmit a frequency which may be below the carrier frequency. If the synthesizer may be operating except for VCO 905 than the charge pump may push the voltage over the loop filter either up for ‘0’ or down for ‘1’. Hence a threshold 920 over the differential voltage of the loop filter may be used for the binary decision. The comparison frequency may be raised to decrease the limit cycle phenomena that may occur when the frequencies used are too far from the carrier frequency. One advantage of this embodiment may be its very simple structure. Most units may already have a regular synthesizer design. Another advantage may be that it may use a non-linear amplifier 909 since only zero-crossing information may be extracted. A low-noise-amplifier (LNA) 907 and non-linear amplifier 909 may support minimal gain allowing the hard limiter 912 to function.

Size and power constraints of typical autonomous in-vivo devices may, for example, restrict the circuitry size and/or reception capability of an in-vivo receiver. According to some embodiments of the present invention, spread spectrum communication may be implemented for high power transmission of, for example, a constant envelope signal to an in-vivo device.

Reference is now made to FIG. 13 showing a portion of a transmitter for transmitting a FSK modulated signal according to an embodiment of the present invention. In one embodiment of the present invention, a component such as for example an I/Q modulator 710 may, for example, be used to create a wide bandwidth and/or spread spectrum carrier signal, the signal may be amplified or attenuated (720) to a desired gain, for example, to a gain that will facilitate reception in-vivo despite attenuation. Other methods may be used to generate an FSK modulated signal with a wideband spectrum.

In some embodiments, transceiver 49 may be a single integrated circuit providing both reception and transmission of wireless signals. Use of a single integrated circuit for both reception and transmission of wireless signals by device 40 may in some embodiments reduce the space and power requirements that may otherwise be faced by autonomous in-vivo devices with two-way wireless capabilities.

Transceiver 49 may operate using radio waves, but in some embodiments, other wireless transmission media may be used. In some embodiments transceiver 49 may receive wireless signals on a particular frequency and may transmit wireless signals on such same frequency. In such or other cases, for example, the transmission of wireless signals by for example transmitter 13 may alternate in time with the transmission of wireless signals by transceiver 49 so that such two components may not transmit at the same time. For example, reception of wireless signals by transceiver 49 may be programmed to occur during any idle transmission time, for example, during the period when illumination source 42 may be illuminating an in-vivo area. In other embodiments other periods of idle transmission may be used for reception of wireless signals. In other embodiments of the present invention, the period of reception may be shorter or longer than the period of illumination or may occur at other suitable periods, other than the period of illumination. In a further embodiment, transceiver 49 may transmit a beacon or other transmission request signal at various intervals to indicate to, for example, receiver 12 that transceiver 49 is ready to receive a transmission.

According to some embodiments of the invention, transceiver 49 may receive wireless transmission on a different frequency than the frequency used for transceiver 49 transmission. In such a case both transmitter 13 and transceiver 47 may transmit at the same time using different frequencies and implementing, for example, a full-duplex communication.

According to some embodiments of the invention, a series of symbols may form a packet, which may be sent after each activation and/or trigger of the downlink channel. Implementing a parsing algorithm, may lead to a parsed structure of the packet. The length of the packets may vary and may be specified in a packet preamble.

In some embodiments of the present invention, a simple automatic repeat request (ARQ) scheme similar to, for example, TCP/IP protocol may be included to provide high reliability in the communication channel. For example, a cyclical redundancy code (CRC) may be provided by the transmitter 13 for confirmation. The transceiver 49 may acknowledge the transmitter 13 if a message was transmitted correctly. In case of failure the message may be retransmitted until successful or some arbitrary timeout expires. Other suitable methods of confirmation may be used. In other embodiments of the present invention, confirmation may not be implemented.

In some embodiments wireless signals transmitted from transmitter 13 to transceiver 49 may be modulated with amplitude modulation. Alternatively or in addition, frequency modulation may be used for transmitting such or other signals to or from device 49.

Reference is made to FIG. 14, showing a flow chart of a method in accordance with an embodiment of the invention. In block 1410 a wireless signal may be received by a transceiver in an in-vivo device. In some embodiments, such wireless signal may be or may include a control or command signal in response to which for example an operations state of such in-vivo device may be activated, deactivated or otherwise altered. In some embodiments such wireless signal may be modulated using amplitude modulation and may be transmitted from an external transmitter using a non-continuous and high-resolution signal. In some embodiments the command or control information that is received by the transceiver may be or may include a small amount of information and may have been transmitted from an external receiver at a very low transmission rate such as for example between 1-10 kbits. Other rates may be used.

In block 1420, another wireless signal may be transmitted by for example the transceiver in such in-vivo device. Such other wireless signal may be or include sensed data collected by such in-vivo sensing device, such as for example image data of the GI tract. The wireless data of block 1420 may also include a reply including for example an acknowledgment that the signal of block 1410 has been received. In some embodiments, a wireless signal that is received by the transceiver may have been transmitted on the same radio frequency as the wireless signal that is transmitted by the transceiver.

It will be appreciated by persons skilled in the art that the present invention is not limited to what has been particularly shown and described hereinabove. Alternate embodiments are contemplated which fall within the scope of the invention.

1-21. (canceled)

22. An in-vivo imaging system comprising:
an in-vivo device comprising a transceiver to transmit data to an external receiver/recorder at a first rate, the data including at least image data; and
a transmitter external to the in-vivo device to transmit data at a second rate;
wherein the first rate is higher than the second rate.

23. The system of claim 22, wherein said transmitter transmits data at said second rate using an OOK modulation structure.

24. The system of claim 22, wherein said transmitter transmits data using an OOK modulation structure using a variable frequency signal for representing a mark resulting in spread spectrum.

25. The system of claim 22, wherein said transmitter transmits data using a variable frequency carrier signal.

26. The system of claim 25, wherein said transmitter transmits data using a chirp signal resulting in spread spectrum.

27. The system of claim 25, wherein said transmitter transmits data using a down-chirp or an up-chirp carrier signal for one bit representation.

28. The system of claim 22, wherein said transceiver transmits data to said external receiver/recorder using time division multiple access.

29. The system of claim 22, wherein said transmitter transmits data using time division multiple access method.

30. The system of claim 22 wherein said transmitter and said transceiver use different transmission frequencies.

31. The system of claim 22 wherein said transmitter and said transceiver transmit at the same time.

32. The system of claim 22 wherein said transmitter is to transmit data representing control instructions to said transceiver, said data having a spread spectrum modulation structure and said in-vivo device executing the control instructions.

33. The system of claim 22 comprising an imager to capture image data of portions of a body lumen.

34. A method for transmitting data from an in-vivo device to a receiver/recorder and from an external transmitter to the in-vivo device, the method comprising:
transmitting data at a first rate from said in-vivo device to said receiver/recorder, the data including at least image data;
transmitting data at a second rate from said transmitter to said in-vivo device;
wherein the first rate is higher than the second rate.

35. The method of claim 34 comprising transmitting data at a second rate using OOK modulation structure with a constant frequency carrier signal or a variable frequency carrier signal representing a mark resulting in spread spectrum modulation structure.

36. The method of claim 34, comprising transmitting data at a second rate using a variable frequency carrier using a chirp signal resulting in spread spectrum modulation structure.

37. The method of claim 34 comprising transmitting data at a second rate using variable frequency carrier resulting in a spread spectrum structure using a down-chirp or up-chirp signal for one bit representation.

38. The method of claim 34, comprising transmitting data at a first rate or at a second rate using time division multiple access.

39. The method of claim 34, comprising capturing image data of portions of a body lumen using an imager.
